(19) United States
(12) Patent Application Publication
(10) Pub. No.: US 2004/0085463 A1
(43) Pub. Date: May 6, 2004

(54) Imaging system with non-volatile memory

(76) Inventors: Manish Sharma, Sunnyvale, CA (US); Frederick A. Perner, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/289,997

(22) Filed: Nov. 6, 2002

(51) Int. Cl. H04N 5/76; H04N 5/335

(52) U.S. Cl. 348/231.99; 348/308

(57) ABSTRACT

A method and system for capturing and storing image data is disclosed. The imaging and information storage apparatus comprises an imaging device, an analog to digital converter, and a persistent or non-volatile memory store. The imaging device captures image data that is then forwarded to the analog to digital converter for conversion. The digital information is then stored within the persistent memory store in a manner consistent with the actual acquisition of the image data by the imaging device.

### BACKGROUND OF THE INVENTION

1. Field of the Invention

The present invention relates to an imaging system and, more particularly, the present invention relates to an imaging system with a non-volatile memory store.

2. Related Art

Imaging technology processes incoming image data into an analog or digital signal representing the imaging data. Imaging systems have broad applications and are found in commercial, consumer, industrial, medical, defense, and scientific markets.

The original image sensors included an array of photosensitive elements in series with switching elements. Each photosensitive element received an image of a portion of the scene being imaged. That portion is called a picture element or pixel. The image obtaining elements produce an electrical signal indicative of the image.

The development of solid-state charge coupled devices (CCD) in the early 1970s led to more compact image systems. CCDs use a process of repeated lateral transfer of charge in an MOS electrode-based analog shift register. Photo-generated signal electrons are read after they are shifted into appropriate positions. The shifting process, however, requires high fidelity and low loss. A specialized semiconductor fabrication process was used to obtain these characteristics.

Active pixel sensors are an alternative to CCDs. Active pixel sensors use special techniques to integrate both the photo detector and the supporting electronics necessary for processing the incoming data for output by integrating both the photo detector and the processing electronics into the pixel area or at least adjacent to the pixel area. This allows the signal indicative of the pixel to be read out directly. These techniques have enabled use of a logic family whose fabrication processes are compatible with CMOS. This has enabled the controlling circuitry to be made from CMOS or some other low-powered dissipating logic family.

Both CCD systems and active pixel sensor systems have advantages and disadvantages, but are both well accepted in the art as being useful imaging sensors.

Typically, the information that is converted from the CCD or active pixel sensor is held within a buffer for transfer to a storage medium, often that medium is flash memory. Further, the information may be transferred to a non-volatile long-term storage device such as a hard disk or CD write disk. Other storage techniques are possible, but they are merely ancillary to the actual imaging system with its designed buffer.

The common storage mode is to use flash memory. Flash memory typically requires high voltages to perform read and write operations. Also, the write time is very slow. With the high-voltage requirements, the power source is limited with respect to efficiency and longevity.

Accordingly, what is needed is a system that is able to store pixel information converted from the imaging sensors in a fast and uniform way over that of the prior art. Further, what is needed is a memory system that reduces the power requirements over that of the prior art as well as reduces the expense of the overall system.

### SUMMARY OF THE INVENTION

According to the present invention, a method and system for capturing and storing image data is disclosed. The imaging and information storage apparatus comprises an imaging device, an analog to digital converter, and a persistent or non-volatile memory store. The imaging device captures image data that is then forwarded to the analog to digital converter for conversion. The digital information is stored within the persistent store in a manner consistent with the actual acquisition of the image data by the imaging device. Since the MRAM device is fabricated in semiconductor material, it may be integrated with the imaging device and ADC converter, which are also fabricated in semiconductor material.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic diagram of an imaging device with non-volatile memory in accordance with an embodiment of the present invention;

FIGS. 2a-c are perspective top views of the imaging device of FIG. 1;

FIG. 3 is a cross-sectional view of an imaging cell as embodied in the present invention;

FIG. 4 is a perspective view of storage portions of the imaging device of FIG. 1 as embodied in the present invention;

FIG. 5 is a schematic diagram of an active pixel imaging cell as embodied in the present invention;

FIG. 6 depicts a schematic diagram of a memory array as embodied in the present invention along with control logic for accessing the cells within the array;

FIG. 7 illustrates a schematic diagram of a sense amplifier as embodied in the present invention for use within the memory storage array; and

FIG. 8 is a block diagram of the process of capturing and storing pixel information as performed by the imaging device of FIG. 1.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

An imaging device integrated with a persistent memory store is disclosed in the present invention. The imaging device typically is a charge-coupled device (CCD) or an active pixel imager, an example of which is disclosed in U.S. Pat. No. 6,018,187, incorporated by reference for all purposes. The memory store comprises an array of persistent memory cells such as magnetic random access memory (MRAM) or other types of similar persistent stores such as ferroelectric RAM (FeRAM). Accordingly, the memory array operates at the same speeds as the imaging device such that as data are collected and then converted to a digital value, they can be written to the memory array at a speed matching the data output of the imaging device. The persistent memory store operates at a reduced power over that of the prior art, thereby conserving battery resources when implemented in a portable system as well as keeping the chip cooler due to lower power requirements.

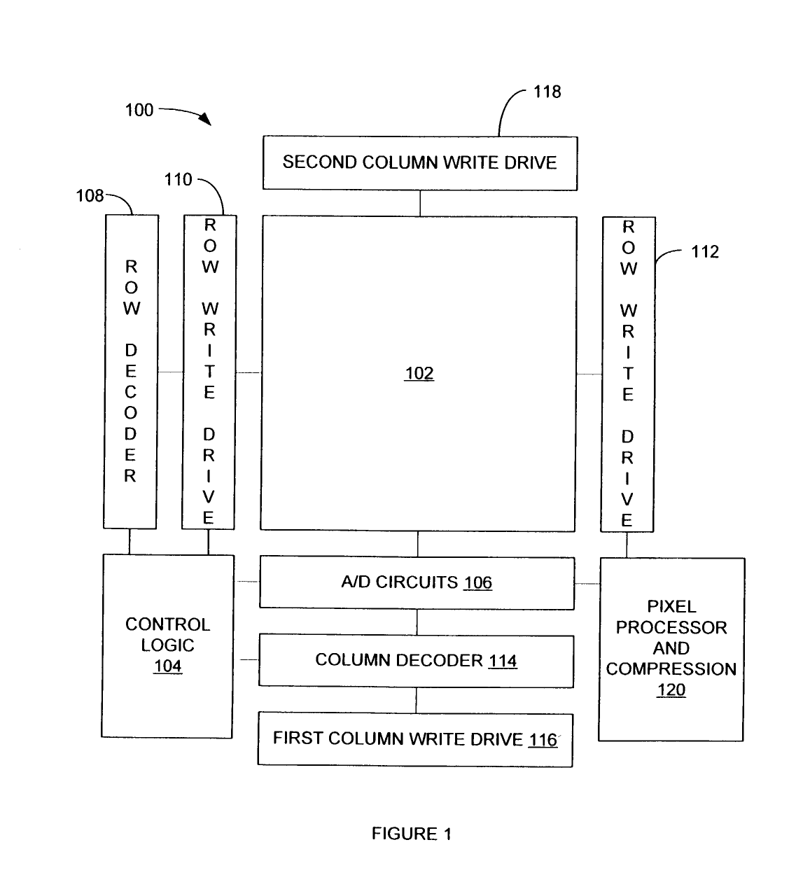

An imaging device 100 is illustrated in the schematic diagram of FIG. 1. Imaging device 100 includes an imager and memory array 102. The imager portion of array 102 can comprise either a charge-coupled device (CCD) or an active pixel imager, or other suitable imagers. The memory store of array 102 comprises a persistent or non-volatile memory store such as MRAM, FeRAM, or other types of persistent memory stores that are compatible with the fabrication process of the imaging portion of array 102.

The imaging device 100 further includes support circuitry such as control logic 104, an analog to digital converter (ADC) circuit 106, a row decoder 108, a first row write drive 110 and a second row write drive 112. The device 100 further includes a column decoder 114, which also couples to ADC circuit 106, a first column write decoder 116, and a second column write drive 118. The device 100 further includes a pixel processor and compression circuit 120.

Both the pixel array and the memory array portions of imager and memory array 102 are driven by the on-chip electronics stated above. Control logic 104 provides timing and control circuits to control the imager array 102 during the image capture process, to the control the transfer of image data out of the imager array to the ADC 106 and pixel processing circuits120, and to control the writing and reading of processed image data to the memory array 102. Row decoder and write drivers 108, 110 and 112 select which row shall provide readout as well as to which row shall be written. A specific row is selected by entry of a row value that is output from control logic 104. Control logic 104 further comprises selected latches and counters that are used to store the row values to provide selection of subsequent rows that follow the current row based on the count within the counter. Similarly, columns can be selected and accessed by the latches within control logic 104 through column decoder 114 and column write drivers 116 and 118. Typically, the first row driver 110 services the imaging array portion of imager and memory array 102 while the second row driver 112 services the memory array portion of array 102. Likewise, first column write drive 116 services the imaging array portion of imager and memory array 102 while the second column write drive 118 services the memory array portion of array 102.

Pixel processor and compression circuit 120 receives the raw data information from the imaging array portion through the ADC circuits 106 to convert it into useful information based on the threshold values achieved during a collection time to define light intensity, pixel intensity, pixel color, and other pixel information, while the compression portion compresses the information in a manageable format to conserve memory space. The ADC circuits 106 convert image data from its analog form as collected by the imaging array portion into a digital form as necessary for pixel processing and storage within the memory array portion of array 102.

When compression is used it is performed after the analog-to-digital conversion has taken the original analog data and converted it to digital data. Note that the compression scheme used depends on the design. There are three ways to design the circuit. In one embodiment, it is possible to have a one-to-one direct correspondence between an MRAM cell and an image pixel. In that case, the data from the pixel is transferred directly to the MRAM cell. In such a scheme, there will not be any compression and the number of MRAM cells will be directly proportional to the number of pixels.

In another embodiment, it is possible to have different color detectors at the same pixel (say, Red, Green, Blue). So, multiple color detectors, typically three, but it can be more, form one pixel in the array. To store these multiple data points, one will need to have more than one group of MRAM cells per pixel. So, if there are three color data points per pixel, there would normally be a need for three groups of MRAM cells. Compression can be utilized instead to reduce this number of MRAM cells. In this scheme, there would still be a one-to-one correspondence where each pixel will have n number of color data and m number of MRAM cells.

In yet another embodiment, one can sacrifice the one-to-one correspondence, gather all the data from the imaging array, pass it through the compression circuits and then store the compressed data as a block in the MRAM array. This third alternative provides the most efficient compression, but performs more slowly than the other embodiments.

The MRAM array portion utilizes four conductors, which allows the row and column decode and write overhead circuits to be moved to the edges of the substrate upon which the imager and memory array 102 is fabricated and to allow for an imager array design that avoids internally restricted blocks. Further, the MRAM array may be separated into smaller arrays, thereby allowing the use of a dedicated sense amplifier for each array that is small enough to fit under the photodiode and memory array layers within the semiconductor substrate. Further, additional support circuits necessary for the memory array are also fabricated within the semiconductor material. The additional circuits include, but are not limited to, row and column taps. To improve upon efficiency, the support circuits are set up in a shared manner so as to operate with a limited number of adjacent pixels. In one embodiment, the support circuits operate with four adjacent pixels, but fewer or greater numbers of pixels may be supported.

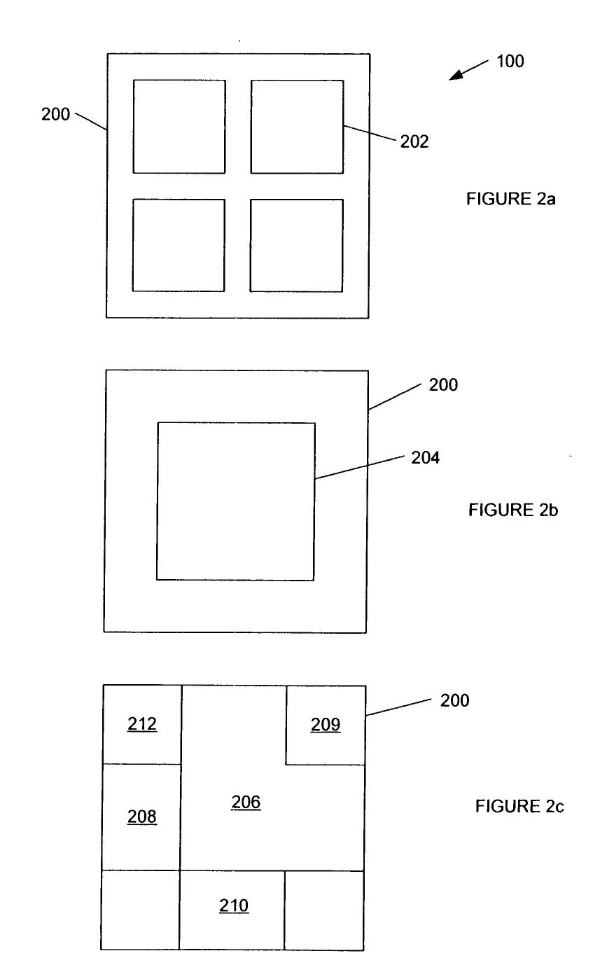

Since the support electronics, memory array, and imaging array for imaging device 100 may be fabricated in the same semiconductor material, but at different layers therein, FIGS. 2a-c illustrate a top view of each layer within the same semiconductor material. FIG. 2a illustrates the top layer that includes amorphous-silicon (α-Si) photodiode sensors 202. FIG. 2b illustrates the non-volatile or persistent memory array 204. FIG. 2c illustrates the support electronics, which lie below the layer of FIG. 2b and in the top surface layer of the substrate of the semiconductor material and includes pixel contacts 212 for connecting the pixels 202 of top surface shown in FIG. 2a with the control circuitry of FIG. 2c. The control circuitry 209 of FIG. 2c includes the write drivers 110, 112, 116, 118, column decoder 114, row decoder 108, control logic 104, ADC circuit 106, and the pixel processor and compression circuit 120 device of FIG. 1. Further, a plurality of sense amplifiers 206 are provided for performing the read operation of sensing the status of the memory bits located within the MRAM array 204 of FIG. 2b. Additional supporting electronics includes row taps 208 and column taps 210, which are described in greater detail below.

A representative physical embodiment of the imaging and memory array device as embodied in the present invention includes four squares of α-Si sensors 202 wherein each pixel is provided in a space of 16 micrometers². The overall surface area of the imaging device 100 is approximately 50 mm², being generally 7 mm per side. This can yield approximately 3 million pixel sensors within the 50 mm² surface area. The surface is then broken down into four pixel-arrays that operate independent of one another.

The second layer includes the non-volatile or persistent memory array 204, which in this case is a 64-bit MRAM array that is approximately 3.2 micrometers per side. The 64-bit memory array is divided into three sections that include sixteen bits each. Each section corresponds to one of three primary colors describing the image from the pixel in the top layer or surface of the device 100 illustrated in FIG. 2a. Since there are 3 million pixels within the entire device 100, this yields a memory array having 48 million bits of storage capacity. Alternative embodiments may include larger or smaller MRAM arrays than that described within this disclosure. As such, the dimensions previously described are not to limit the actual imaging and memory device 100 as the size and number of pixels and memory bits may be scaled to suit the needs of the designer. Further, although it is shown to include a single array layer of MRAM cells, multiple layers of MRAM cells may also be incorporated.

The photo detector 202 is an α-Si photodiode fabricated over the top of the silicon circuitry. The use of an α-Si photodiode provides a maximum fill factor that also serves as a light shield to the photosensitive circuitry fabricated below the photo detector array.

The accumulated data within each photo cell or photo detector 202 is forwarded to ADC circuit 106. In one embodiment, ADC circuit 106 is a single slope ADC circuit that includes a gated counter, a voltage ramp generator, and a comparator. In another emobodiement, each pixel may contain a comparator and a register that is connected to the counter through a set of transmission gates controlled by an in-pixel comparator. Thus, each pixel operates as an independent “single slope” ADC circuit synchronized to a single counter and a single reference ramp voltage.

The imager and memory array 102 is fabricated in a semiconductor material, such as silicon. The imaging portion of array 102 comprises an array of large area α-Si photodiodes 202 as shown in FIG. 2a. Phototransistors may substitute for the photodiodes in alternative embodiments. A large surface area for the photo diodes is necessary as the area of the photo detector dedicated to photon collection is determined by the optical properties of the imager.

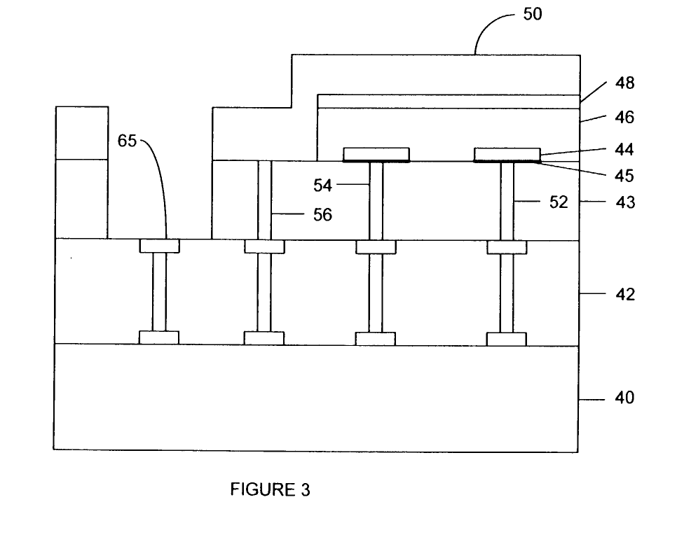

The imaging portion is fabricated on top of the semiconductor material, typically after the fabrication of the memory array. A cross section of the imaging array along with a description of its manufacture is illustrated in FIG. 3. An interconnection structure 42 is formed adjacent to the substrate 40. Substrate 40 includes the memory array portion and other support circuitry and electronics utilized within the device 100. A pixel interconnect structure 43 is formed adjacent to the interconnection structure 42. Pixel electrodes 44 and an inner metal section 45 are formed adjacent to the pixel interconnect structure 43. Each pixel sensor of an array of pixel sensors includes an individual pixel electrode 44 and an inner metal section 45. A lightly doped α-Silicon photo sensor layer 46 is formed adjacent to the pixel electrodes 44. A P-doped α-Silicon layer completing the photo diode sensor 48 is formed adjacent to layer 46. A transparent conductor 50 is formed adjacent to the P-layer 48. The pixel electrode 44 of a first pixel sensor is electrically connected to the substrate 40 through a first conductive via 52. The pixel electrode 44 of a second pixel sensor is electrically connected to the substrate 40 through a second conductive via 54. The transparent conductor 50 is electrically connected to the substrate 40 through a third conductive via 56.

The pixel sensors conduct charge when the pixel sensors receive light. The substrate 40 generally includes the memory array, sense circuitry and signal processing circuitry. The sense circuitry senses how much charge the pixel sensors have conducted. The amount of charge conducted represents the intensity of light received by the pixel sensors. Generally, the substrate can be CMOS (complementary metal oxide silicon), BiCMOS or Bipolar. The substrate then processes the pixel charge using the circuitry fabricated therein and then stores the processed data within the memory array portion also fabricated therein.

Typically, the interconnection structure 42 is a standard CMOS interconnection structure. The structure and methods of forming this interconnection structure are well known in the field of electronic integrated circuit fabrication. The interconnection structure 42 can be a subtractive metal structure, or a single or dual damascene structure.

The pixel interconnect structure allows for the formation of thin pixel electrodes 44 because the pixel electrodes 44 are formed over silicon rather than a metal pad located on the interconnection structure 42. The pixel interconnect structure 43 electrically connects the pixel electrodes 44 to the interconnection structure 42. The insulating material within the pixel interconnect structure 43 is typically formed from a silicon oxide or a silicon nitride.

The conductive vias 52, 54 pass through the pixel interconnect structure 43 and electrically connect the pixel electrodes 44 to the substrate 40. The third conductive via 56 passes through the pixel interconnect structure 43 and provides a reliable electrical connection between the transparent conductor 50 and the substrate 40. Typically, the conductive vias 52, 54, 56 are formed from tungsten. Tungsten is generally used during fabrication because tungsten can fill high aspect ratio holes. That is, tungsten can be used to form narrow and relatively long interconnections. Typically, the conductive vias 52, 54, 56 are formed using a chemical vapor deposition (CVD) process. Other materials that can be used to form the conductive vias 52, 54, 56 include copper, aluminum or any other electrically conductive material.

The inner metal section 45 should include a thin conductive material. The inner metal section 45 may be formed, for example, from a degenerately doped semiconductor layer, aluminum, titanium, titanium nitride, copper or tungsten. The inner metal section 45 should be thin (approximately 500 Angstroms) and smooth. The inner metal section 45 should be smooth enough that any surface roughness is substantially less than the thickness of the pixel electrode 44 formed over the inner metal section 45. To satisfy the smoothness requirement, polishing of the inner metal section 45 may be required.

The inner metal section 45 can be optional; however, the inner metal section 45 has a lower resistance than the materials used to form the pixel electrodes 44. Therefore, the inner metal section 45 provides better current collection.

The pixel electrodes 44 are generally formed from a doped semiconductor. The doped semiconductor can be an N-layer of amorphous silicon. The pixel electrode must be thick enough, and doped heavily enough that the pixel electrodes 44 do not fully deplete when biased during operation. The pixel electrodes 44 are typically doped with phosphorous or arsenic.

The pixel electrodes 44 are typically deposited using plasma enhanced chemical vapor deposition (PECVD). The PECVD is performed with a phosphorous containing gas. The phosphorous gas can be PH₃. A silicon containing gas is included when forming amorphous silicon pixel electrodes.

An N-layer of amorphous silicon is typically used when forming PIN diode active pixel sensors. However, the diode active pixel sensors can include an NIP sensor configuration. In this case, the pixel electrodes 44 are formed from a P-layer, and the P-layer 48 of FIG. 3 is replaced with an N-layer.

The layer 46 is generally formed from hydrogenated amorphous silicon. The layer 46 can be deposited using a PECVD or a reactive sputtering process. The PECVD process must include a silicon containing gas. The deposition should be at a low enough temperature that hydrogen is retained within the film. The layer 46 is approximately one micron thick.

The layer 46 electrically connects to the transparent conductor 50. The layer 46 includes a resistive path between the electrodes 44 and the transparent conductor 50. An edge electrode, such as the electrode 44 electrically connected to the conductive via 54, should be located so that there is a large physical distance between the edge of the electrode and the transparent conductor 50.. This requirement for the edge electrodes is to reduce imager processing costs by eliminating the need to passivate the edges of the photo sensor array defined by the layer 46. Increasing the distance minimizes edge related leakage currents.

The P-layer 48 is generally formed from amorphous silicon. Typically, the P-layer 48 is doped with boron. The P-layer 48 can be deposited using PECVD. The PECVD is preferably performed with a boron containing gas. The boron containing gas can be B₂H₆. A silicon containing gas is included when forming an amorphous silicon P-layer 48. The P-layer 48 thickness may generally be controlled to ensure that the P-layer 48 does not absorb too much short wavelength (blue) light.

As previously described, the pixel electrodes 44, the layer 46 and the P-layer 48 are generally formed from amorphous silicon. However, the pixel electrodes 44, the layer 46 and the P-layer 48 can also be formed from amorphous carbon, amorphous silicon carbide, amorphous germanium, or amorphous silicon-germanium. It should be understood that this list is not exhaustive.

The transparent conductor 50 provides a conductive connection between the P-layer 48 and the layer 46 of the pixel sensors, and the interconnection structure 42. Light must pass through the transparent conductor 50 and the P-layer 48 so that the majority of the visible light is absorbed in the pixel sensor layer 46. Generally, the transparent conductor 50 is formed from an indium tin oxide. However, the transparent conductor 50 can also be formed from titanium nitride, thin silicide, or certain types of transition metal nitrides or oxides.

Both the selection of the type of material to be used within the transparent conductor 50 and the determination of the desired thickness of the transparent conductor 50 are based upon minimizing the optical reflection of light received by the pixel sensor. Minimization of the reflection of light received by the pixel sensor helps to optimize the amount of light detected by the pixel sensor.

The transparent conductor 50 can be deposited by a sputtering process. Deposition through sputtering is well known in the art of integrated circuit fabrication.

A protective layer may be formed over the transparent conductor 50. The protective layer provides mechanical protection, electrical insulation, and can provide some anti-reflective characteristics.

The photo sensor structure and method of fabrication just described are merely exemplary of a type of structure that can be used. Other types of photo sensor structures may be freely substituted and are well within the ability of the skilled artisan.

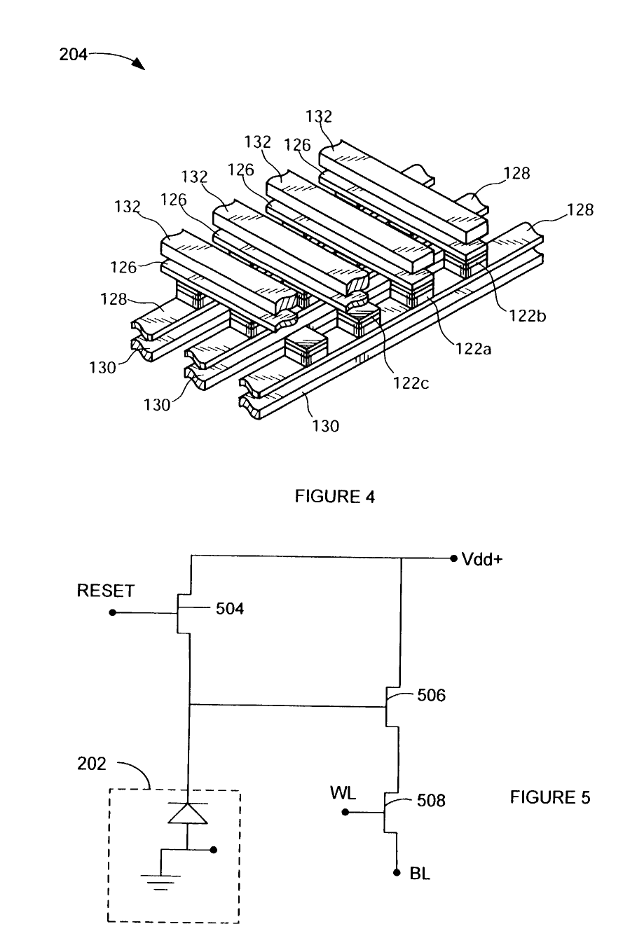

Prior to the formation of the imaging portion of array 102, the memory portion of array 102 is fabricated on the substrate of the semiconductor material. In this case, an MRAM array 204 of FIG. 2b is fabricated as a thin film memory structure using CMOS processing techniques that are compatible with the fabrication of the photodiodes utilized in the imaging portion of imager and memory array 102. An example of a memory array comprising a plurality of MRAM cells is illustrated in FIG. 4, which depicts a 4-conductor MRAM memory cell.

Exemplary materials, thicknesses, and process stops of an MRAM cell 122 within array 204 are also described with reference to FIG. 4. MRAM cell 122 in an exemplary embodiment comprising a fixed ferromagnetic layer 122a, such as Co—Fe or permalloy, a thin tunneling barrier layer 122b of alumina (Al₂O₃), and a soft ferromagnetic layer (FMS) 122c, such as a sandwich of thin Co—Fe with permalloy. In one embodiment, the memory cell 122 is a magnetic tunneling junction cell. The cell further includes a contact layer or bit line 126, such as Pt. Other types of MRAM cells may be substituted.

On substrate 40 (not shown), word lines 128 are formed and covered with an insulating layer of SiO₂. The surface on which MRAM cell 122 is formed is etched and planarized exposing the surface of the metal word lines 128. Next, the series of layers that make up MRAM cell 122 are deposited by magnetron sputter deposition uniformly on this surface, which is held near ambient temperature. First, a suitable thickness of N₈₁Fe₁₉ alloy FMF layer 122a is deposited on the surface. The insulating tunneling barrier 122b is formed on top of FMF layer 122a by depositing a thin layer of Al, which is then oxidized at an oxygen pressure of 100 mTorr and a power density of 25 W² for 60 to 240 seconds to form the insulating tunnel barrier layer 122b of Al₂O₃. A soft ferromagnetic layer FMS 122c is formed on the barrier layer 122b. The FMS layer 122c comprises a thin layer of Co—Fe alloy, a layer of N₈₁Fe₁₉ alloy, and a thin Pt layer. At this point, there is a single large MTJ that covers the entire surface of substrate 40. This large MTJ is then patterned into many small MTJs, such as cell 122, by photoresist masking and Ar ion milling down through the stack of layers to the surface of an insulator layer used in separating the word lines 128. Bit lines 126 are then formed on top of the structure using electromigration-resistant thin film materials of silicon VLSI processing, such as Ta, Al—Cu alloys, Cu, or W wiring materials. The bit lines 126 are part of the contact layer. Again, the cell array and method of fabrication are merely exemplary. Other cell arrays and methods of fabrication may be freely substituted and are left to the skilled artisan.

Global word lines 130 are fabricated below the sense word lines 128 and global bit lines 132 are fabricated above the sense bit lines 126. Global lines 130 and 132 are thick conductors formed with a NiFe cladded copper damascene process and are used in both the MRAM sense and write operations. The array size need not be limited to 4×4, other sizes are also possible and are contemplated within the scope of the present invention. Further, there need not be equal numbers of rows and columns such that the array can be N×M.

A photo detector circuit that subsequently connects to a memory store is shown in FIG. 5. The pixel is selected to be an amorphous-Si diode 202, which is further coupled to a control transistor 506 and a reset transistor 504. The control transistor 506 is further coupled to the voltage source V_{DD} as is the reset transistor 504. Further, control transistor 506 is further coupled to a second control transistor 508, which is activated by the write line to enable the data collected by diode 202 to be sent to the appropriate bit line also connected to control transistor 508. After a image sense operation has been performed, the circuit is reset by activating reset circuit 504 to restore a full charge across diode 202 so that a new photon collection sequence may be performed.

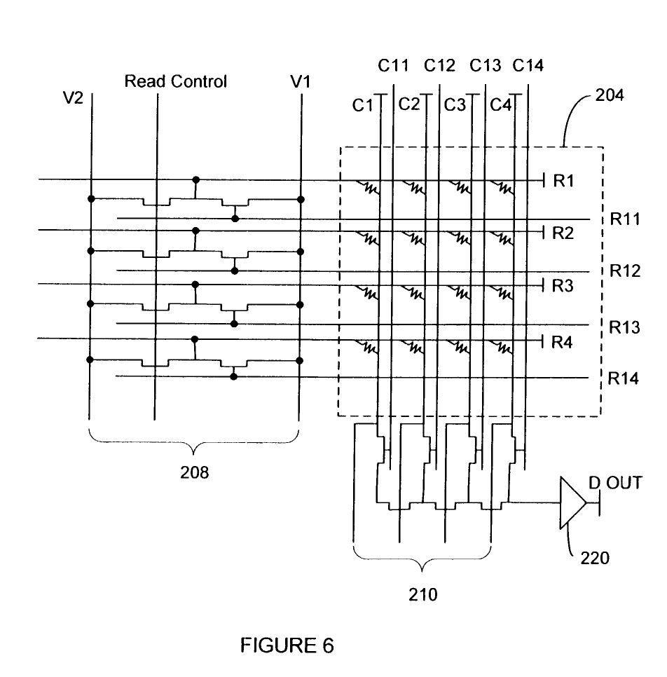

An embodiment of the persistent or non-volatile memory array portion of imaging device 100 is shown in greater detail in FIG. 6. A plurality of four by four arrays 204 are depicted that include row tap circuitry 208 and column tap circuitry 210, with the output going to a non-destructive read sense amplifier 220. The persistent memory array includes a four conductor MRAM cell with two local sense and word line conductors and two global column and row write conductors. Local row and column taps are also provided to connect the global row and column lines to the respective local word line and sense lines. Array 204 illustrates two separate layers of 16-bit memory arrays with separate local word lines and sense lines as well as a global column and row write conductors. The global row and column decoders are also shared between the read and write modes of operation. A row group select control signal is used to select the proper row and control the power supply to a sense amplifier 220.

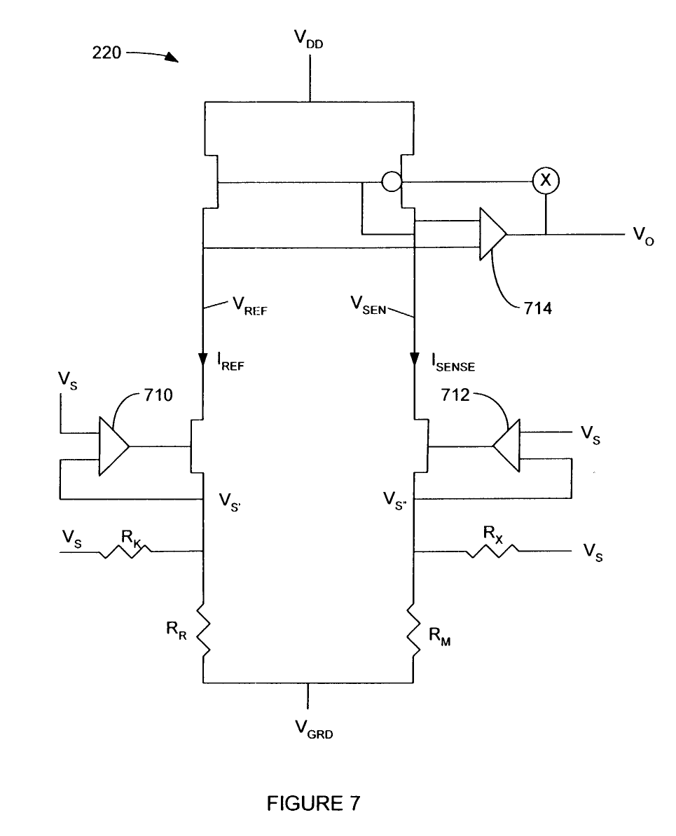

The sense amplifier 220 is depicted in FIG. 7 and operates as an adjustable current mode differential amplifier (ACMDA) with equipotential isolation. Amplifier 220 includes two equipotential preamplifiers 710 and 712 that receive a first voltage input V_{S} with feedback from their respective circuit path. One circuit path provides a reference circuit and the other circuit path provides a sense circuit where a first resistor R_{R} serves as the reference value and a second resistor R_{M} in the second circuit is the memory cell being sensed during a read operation. Both the reference circuit and the sense circuit feed into a differential mode sense amplifier 714. Both preamplifiers 710 and 712 are initially set such that the equipotential voltage on the bit lines is V_{S′} for the reference circuit and V_{S″} for the sense circuit where both are very close to V_{S}. When the voltage is at V_{S1}, the reference current is at I_{REF1} and the sense current is at I_{SENSE1} with both the voltage V_{SEN1} approximately equal to the voltage of the reference circuit V_{REF1}.

The voltage is then changed from a first voltage V_{S} to a second voltage V_{S2} to provide for a second bias point. Upon this change, the voltage output V_{O} of the differential sense amplifier 714 indicates the relative change between the memory cell resistance R_{M} versus the reference cells resistance R_{R}.

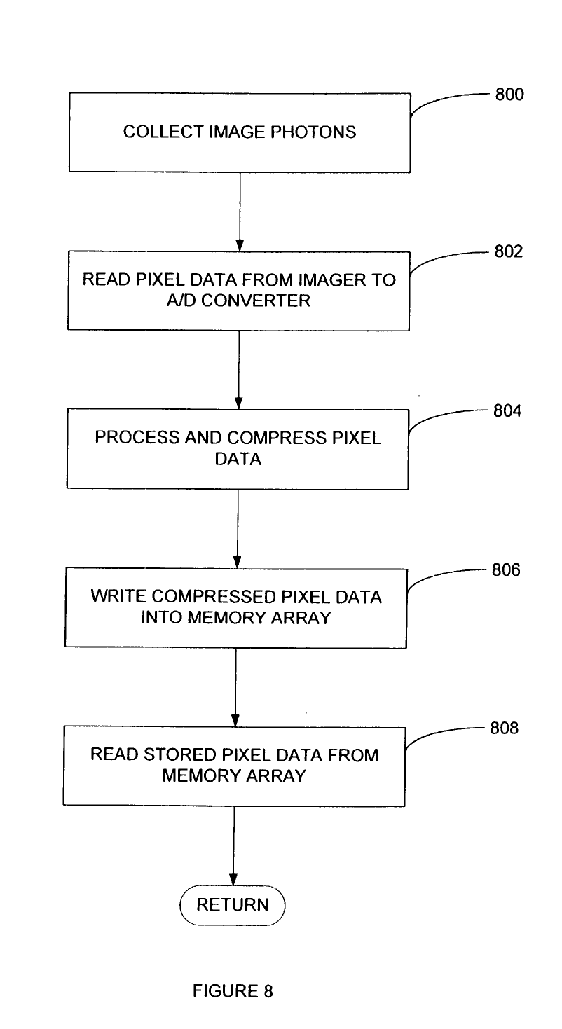

During operation, as shown in the block diagram of FIG. 8, the imager array 102 collects photon information of an image in a timed matter, as shown in block 800. The photon information or pixel information is read one row at a time out of imager array 102 as analog output data (block 802), which is sent in a serial data stream to ADC converter 106 to be converted from analog pixel data to raw digital pixel data. The raw digital data is processed and compressed in the pixel processor 120 (block 804) in real time with the collection of pixel information. Once the pixel information is in a processed and compressed form, it is written into the memory cells of MRAM array 102 (block 806), typically in a serial 30 write operation on the serial data stream sent by the imager array 102. The stored information is read from memory cells 122 (block 808) in a fashion convention with MRAM read operations known to those skilled in the art.

MRAM array 204 operates at speeds comparable to the transfer rate of the imager array 102 and nearly simultaneously, or in real time, with the accumulation and capture of pixel information by imager array 102. As such, memory storage of the data in digital form can be performed at the same rate that it is acquired by the imager array 102. Since MRAM cells function as non-volatile memory stores, once data is written into the cell, it remains there indefinitely until changed or deleted.

Systems typically found in the art required multiple chips in order to provide both the image sensing and the memory storage. Flash imager memory has been utilized, but it requires high voltages to read and write and its write time is very slow compared to the data transfer rate of the imager array 102. By contrast, MRAM memory cells 122 operate at lower power requirements than other memory systems and they write at speeds much faster than flash memory, speeds matching that of imager array 102.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A method of capturing an image, comprising:
capturing analog imaging information in the form of analog pixels in real time;
converting the analog pixels into digital pixel data in real time to the capturing step; and
storing the digital pixel data in a non-volatile storage device in real time to the capturing step.

2. The method according to claim 1 further comprising the step of reading the stored digital pixel data.

3. The method according to claim 1 further comprising the step of performing data compression on the digital pixels before storing the digital pixel data.

4. The method according to claim 1 wherein the capturing step utilizing an active pixel imager to capture the analog imaging information.

5. The method according to claim 1 wherein the capturing step comprises utilizing a charge-coupled device to capture the analog imaging information.

6. The method according to claim 1 wherein the storing step comprises utilizing a magnetic random access memory array as the non-volatile storage device.

7. An imaging and information storage apparatus comprising:
an imaging device that captures analog image data;
an analog to digital converter, coupled to the imaging device, that converts the analog image data into digital data; and
a non-volatile memory store, coupled to the analog to digital converter, that stores the digital data in real time to the capturing of the analog image data.

8. The apparatus according to claim 7 further comprising a data compressor, coupled to the analog to digital converter and the non-volatile memory store, that compress the digital pixels before storing the digital pixel data.

9. The apparatus according to claim 7 wherein the imaging device comprises an active pixel imager.

10. The apparatus according to claim 7 wherein the imaging device comprises a charge-coupled device.

11. The apparatus according to claim 7 wherein the non-volatile memory store comprises a magnetic random access memory array.

12. An imaging and information storage apparatus comprising:
an imaging device, fabricated of semiconductor material, that captures image data; and
a non-volatile memory store integrated with the imaging device and fabricated on the same semiconductor material that stores the image data captured by the imaging device.

13. An imaging and information storage apparatus as claimed in claim 12 further comprising an analog to digital (ADC) converter, coupled to the imaging device, that converts the image data from an analog form into a digital form for storage in the memory store.

14. The apparatus according to claim 13 further comprising a data compressor, coupled to the analog to digital converter and the non-volatile memory store, that compress the digital pixels before storing the digital pixel data.

15. The apparatus according to claim 12 wherein the imaging device comprises an active pixel imager.

16. The apparatus according to claim 12 wherein the imaging device comprises a charge-coupled device.

17. The apparatus according to claim 12 wherein the non-volatile memory store comprises a magnetic random access memory array.

18. A method of manufacturing a combined imaging and memory apparatus, comprising:
fabricating a non-volatile memory data store comprised of an array of storage cells in a semiconductor substrate; and
fabricating an imaging device comprised of an array of imaging cells, each cell coupled to one or more storage cell within the semiconductor substrate.

19. The method according to claim 18 wherein the imaging device comprises an active pixel imager.

20. The method according to claim 18 wherein the imaging device comprises a charge coupled device.

21. The method according to claim 18 wherein the non-volatile memory data store comprises an array of magnetic random access memory cells.
